(19) United States
(12) Patent Application Publication
(10) Pub. No.: US 2012/0169555 A1
(43) Pub. Date: Jul. 5, 2012

(54) MULTIBAND ANTENNA

(75) Inventor: TUN-YUAN TSOU, Tu-Cheng (TW)

(73) Assignee: CHI MEI COMMUNICATION SYSTEMS, INC., Tu-Cheng (TW)

(21) Appl. No.: 13/047,967

(22) Filed: Mar. 15, 2011

(30) Foreign Application Priority Data
Dec. 30, 2010 (CN) 201010614658.3

(51) Int. Cl. H01Q 1/36

(52) U.S. Cl. 343/749

(57) ABSTRACT

A multiband antenna includes a feed unit, a first transceiving unit, a second transceiving unit, and a resonance unit. When feed signals are input from the feed unit, the feed signals are respectively transmitted to the first transceiving unit and the second transceiving unit to enable the first transceiving unit and the second transceiving unit to respectively receive and send wireless signals of different frequencies. In addition, the resonance unit is driven to resonate and serve as a coupled ground resonator that generates additional current paths of at least two different lengths. Such that the resonance unit is enabled to receive and send wireless signals of at least two additional frequencies, and the multiband antenna is further enabled to receive and send wireless signals in more than two frequency bands.

### BACKGROUND

1. Technical Field

The present disclosure relates to multiband communication technology, and particularly to a multiband antenna for portable electronic devices.

2. Description of Related Art

Portable electronic devices, such as mobile phones, personal digital assistants (PDA), and laptop computers, often utilize mounted antennas for receiving/sending wireless signals. Commonly, a portable electronic device may receive/send wireless signals of different frequencies, requiring the presence of a multiband antenna.

However, multiband antennas tend to be large with complicated structure, compromising efforts toward the minimization of portable electronic devices. Even where installation of miniaturized multiband antennas within such portable electronic devices is possible, communication capabilities of miniaturized multiband antennas may be adversely affected due to their limited size. For example, many multiband antennas used in portable electronic devices are unable to receive/send wireless signals in more than two frequency bands.

Therefore, there is room for improvement within the art.

### BRIEF DESCRIPTION OF THE DRAWINGS

Many aspects of the present multiband antenna can be better understood with reference to the following drawings. The components in the various drawings are not necessarily drawn to scale, the emphasis instead being placed upon clearly illustrating the principles of the present multiband antenna. Moreover, in the drawings, like reference numerals designate corresponding parts throughout the figures.

FIG. 1 is a schematic view of a multiband antenna, according to a first exemplary embodiment.

FIG. 2 is a diagram showing RL (return loss) measurement of the multiband antenna shown in FIG. 1.

FIG. 3 is a schematic view of a multiband antenna, according to a second exemplary embodiment.

FIG. 4 is a schematic view of a multiband antenna, according to a third exemplary embodiment.

FIG. 5 is a schematic view of a multiband antenna, according to a fourth exemplary embodiment.

FIG. 6 is a schematic view of a multiband antenna, according to a fifth exemplary embodiment.

### DETAILED DESCRIPTION

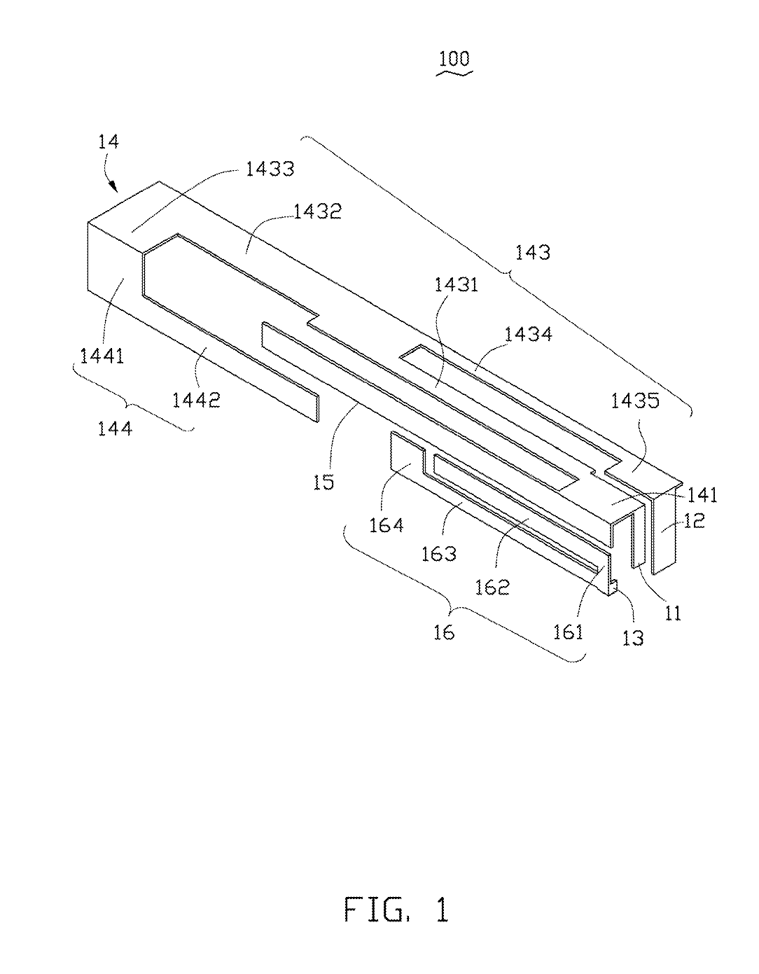

FIG. 1 schematically shows a multiband antenna 100, according to a first exemplary embodiment. The multiband antenna 100 consists of conductive sheets, such that size and profile thereof are minimized, meeting suitability for use in a portable electronic device such as a mobile phone, a personal digital assistant (PDA), or a laptop computer. The conductive sheets can be metal sheets, flexible printed circuits (FPC), or other materials. In this embodiment, the multiband antenna 100 includes a feed unit 11, a first ground unit 12, a second ground unit 13, a first transceiving unit 14, a second transceiving unit 15, and a resonance unit 16.

The feed unit 11, the first ground unit 12, and the ground unit 13 are all substantially rectangular planar sheets, and are positioned coplanar with each other.

The first transceiving unit 14 includes a feed portion 141, a first transceiving portion 143, and a second transceiving portion 144. The feed portion 141 is a substantially rectangular planar sheet positioned in a plane that is perpendicular to the plane in which the feed unit 11, the first ground unit 12, and the ground unit 13 are positioned. The feed unit 11 is connected to an end of a side of the feed portion 141.

The first transceiving portion 143 is a planar sheet positioned coplanar with the feed portion 141. Particularly, the first transceiving portion 143 includes a first transceiving section 1431, a second transceiving section 1432, a third transceiving section 1433, a fourth transceiving section 1434, and a fifth transceiving section 1435. The first transceiving section 1431 is a longitudinal planar sheet. One end of the first transceiving section 1431 is connected to a side of the feed portion 141 that is opposite to the side of the feed portion 141 connected to the feed unit 11. The second transceiving section 1432 is a longitudinal planar sheet that is wider than the first feed section 1431. A side of the first transceiving section 1431 that is adjacent to another end of the first transceiving section 1431 is connected to an end of a side of the second transceiving section 1432. The third transceiving section 1433 is a substantially rectangular planar sheet. One side of the third transceiving section 1433 is connected to another end of the side of the second transceiving section 1432 connected to the first transceiving section 1431. The fourth transceiving section 1434 is a longitudinal planar sheet that is narrower than the second transceiving section 1432. One end of the fourth transceiving section 1434 is connected to an end of the second transceiving section 1432, and the fourth transceiving section 1434 extends substantially parallel to the first transceiving section 1431. The fifth transceiving section 1435 is a substantially rectangular sheet that has a same width as the second transceiving section 1432. Two opposite sides of the fifth transceiving section 1435 are respectively connected to another end of the fourth transceiving section 1434 and the first grounded section 12.

The second transceiving portion 144 is a planar sheet positioned in a plane that is perpendicular to both the plane in which the feed unit 11, the first ground unit 12, and the ground unit 13 are positioned and the plane in which the feed portion 141 and the first transceiving portion 143 are positioned. The second transceiving portion 144 includes a sixth transceiving section 1441 and a seventh transceiving section 1442. The sixth transceiving section 1441 is a substantially rectangular sheet, and the seventh transceiving section 1442 is a longitudinal sheet. One side of the sixth transceiving section 1441 is connected to a side of the third transceiving section 1433 that is opposite to the side of the third transceiving section 1433 connected to the second transceiving section 1432. Another side of the sixth transceiving section 1441 that is opposite to the side of the sixth transceiving section 1441 connected to the third transceiving section 1433 is connected to an end of a side of the seventh transceiving section 1442.

The second transceiving unit 15 is a longitudinal planar sheet positioned coplanar with the second transceiving portion 144. An end of a side of the second transceiving unit 15 is connected to a side of the feed portion 141 that is positioned between the two sides of the feed portion 141 respectively connected to the feed unit 11 and the first feed section 1431. Thus, the seventh transceiving section 1442 and the plane in which the feed portion 141 and the first transceiving portion 143 are positioned are respectively positioned at two opposite sides of the second transceiving unit 15. The second transceiving unit 15 extends towards the sixth transceiving section 1441 and parallel to the plane in which the feed portion 141 and the first transceiving portion 143 are positioned.

The resonance unit 16 is a planar sheet positioned coplanar with the second transceiving portion 144 and the second transceiving unit 15. The resonance unit 16 is connected to the second ground unit 13, and is positioned adjacent to but separated from the feed unit 11, the first ground unit 12, the first transceiving unit 14, and the second transceiving unit 15.

The resonance unit 16 includes a first resonance portion 161, a second resonance portion 162, a third resonance portion 163, and a fourth resonance portion 164. The first resonance portion 161, the second resonance portion 162, and the third resonance portion 163 are all longitudinal sheets. The second ground unit 13 is connected to one end of a side of the first resonance portion 161, and the second resonance portion 162 and the third resonance portion 163 are respectively perpendicularly connected to two ends of another side of the first resonance portion 161. Both the second resonance portion 162 and the third resonance portion 163 extend parallel to the second transceiving unit 15 and towards the distal end of the seventh transceiving section 1442. The second resonance portion 162 and the third resonance portion 163 are both narrower than the seventh transceiving section 1442, and thus both the distal ends of the second resonance portion 162 and the third resonance portion 163 are configured to be substantially aligned with the distal end of the seventh transceiving section 1442. The third resonance portion 164 is a substantially rectangular sheet. One side of the fourth resonance portion 164 is connected to an end of a side of the third resonance portion 163, and the fourth resonance portion 164 is positioned at the same side of the third resonance portion 163 as the second resonance portion 162. Both the second resonance portion 162 and the fourth resonance portion 164 are positioned adjacent to the second transceiving unit 15, i.e., positioned between the third resonance portion 163 and the second transceiving unit 15.

When the multiband antenna 100 is used, the first ground unit 12 and the second ground unit 13 can be attached to a circuit board (not shown) of the portable electronic device to be grounded, and the feed unit 11 is connected to the circuit board to receive feed signals. Feed signals input from the feed unit 11 and the feed portion 141 can respectively transmit to the first transceiving unit 14 and the second transceiving unit 15 to form a plurality of current paths of different lengths. Thus, the first transceiving unit 14 and the second transceiving unit 15 are respectively enabled to serve as antenna members for receiving and sending wireless signals at different frequencies. Simultaneously, the resonance unit 16 is driven to resonate, and thereby is also enabled to serve as an antenna member. In this embodiment, the resonance unit 16 serves as a coupled ground resonator and generates additional current paths of different lengths, which include at least a current path generated in the second resonance portion 162 and a current path generated in the third resonance portion 163 and the fourth resonance portion 164. Thus, the resonance unit 16 can receive/send wireless signals of at least two additional frequencies. In this way, the multiband antenna 100 can be used to receive and send wireless signals in a plurality of different frequency bands.

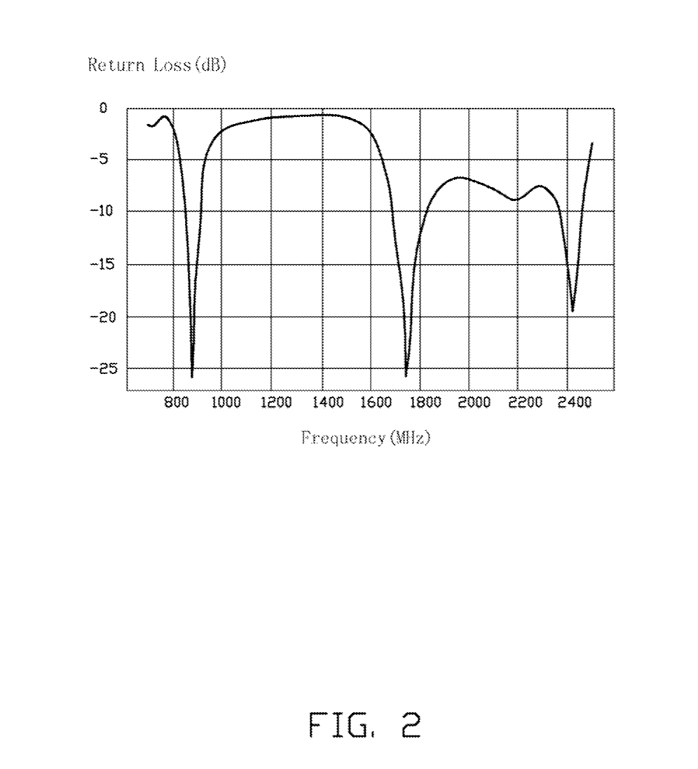

Referring to FIG. 2, as shown in experiments, the return loss (RL) of the multiband antenna 100 is acceptable when the multiband antenna 100 receives/sends wireless signals in multiple frequency bands. Particularly, the RL of the multiband antenna 100 is less than −5 dB when the multiband antenna 100 receives/sends wireless signals at the frequencies of about 870 MHz, 1750 MHz, 2180 MHz, and 2420 MHz. Accordingly, the electronic device employing the multiband antenna 100 can be used in a plurality of (more than two) common wireless communication systems, such as GSM900, DCS1800, PCS1900, or UMTS2100, with acceptable communication quality.

Due to the composition disclosed, in assembly, the multiband antenna 100 can be supported and be protected on a cubic substrate (not shown). In this embodiment, the feed portion 141 and the first transceiving portion 143 can be attached on a top surface of the substrate. The feed unit 11, the second ground unit 12, and the third ground unit 13 can be attached on a side surface of the substrate. The second transceiving portion 144, the second transceiving unit 15, and the resonance unit 16 can be attached on another side surface of the substrate that is perpendicular to both the top surface in which the feed portion 141 and the first feed portion 143 are positioned and the side surface in which the feed unit 11, the first ground unit 12, and the ground unit 13 are positioned. Thus, all parts of the multiband antenna 100 can be flatly attached on the substrate, with an assembly including the substrate and the multiband antenna 100 mounted thereon also defining a substantially cubic outer shape. Accordingly, the multiband antenna 100 is protected from damage, and assembly, installation, and transportation of the multiband antenna 100 are simplified.

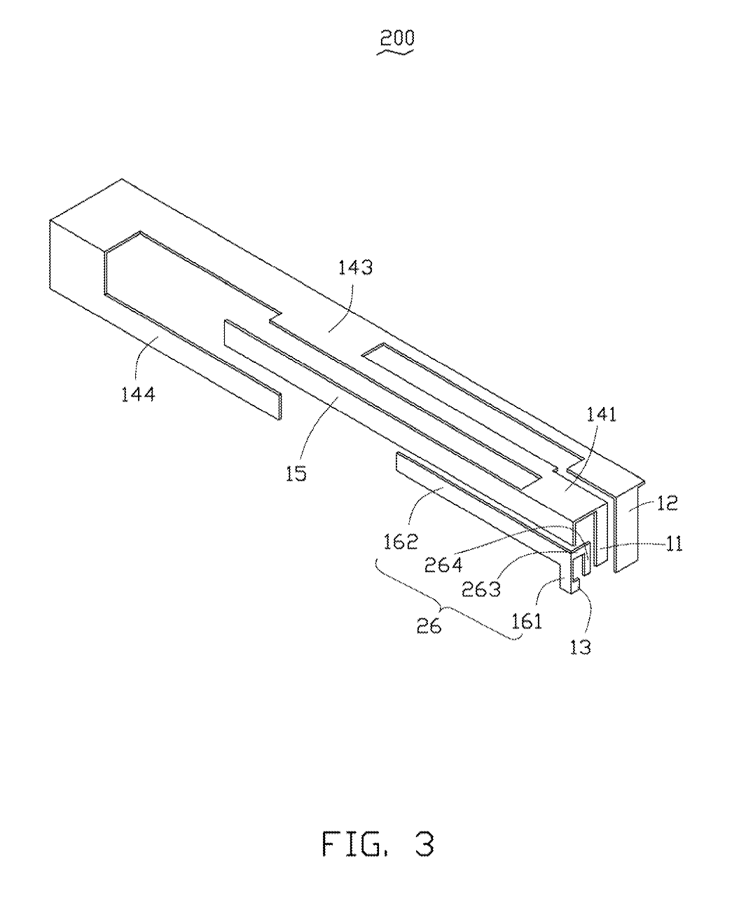

FIG. 3 shows a multiband antenna 200, according to a second exemplary embodiment, differing from the multiband antenna 100 only in that the resonance unit 16 is replaced by another resonance unit 26. The resonance unit 26 differs from the resonance unit 16 only in that another third resonance portion 263 and another fourth resonance portion 264 respectively replace the third resonance portion 163 and the fourth resonance portion 164. The third resonance portion 263 and the fourth resonance portion 264 are both longitudinal planar sheets positioned coplanar with the feed unit 11, the first ground unit 12, and the third ground unit 13. One end of the third resonance portion 263 is connected to another end of the side of the first resonance portion 161 connected to the third ground unit 13, and the third resonance portion 263 extends parallel to the plane in which the feed portion 141 and the first transceiving portion 143 are positioned. The fourth resonance portion 264 is perpendicularly connected to another end of the third resonance portion 263, and extends parallel to the plane in which the second transceiving portion 144, the second transceiving unit 15, the first resonance portion 161, and the second resonance portion 162 are positioned.

In use of the multiband antenna 200, when the resonance unit 26 is driven to resonate, at least a current path generated in the second resonance portion 162 and a current path generated in the third resonance portion 263 and the fourth resonance portion 264 are generated. Thus, the resonance unit 26 can also serve as a coupled ground resonator and generate additional current paths of at least two different lengths, and thereby receive/send wireless signals of at least two additional frequencies. In this way, the multiband antenna 200 can be used to receive and send wireless signals in a plurality of (more than two) different frequency bands.

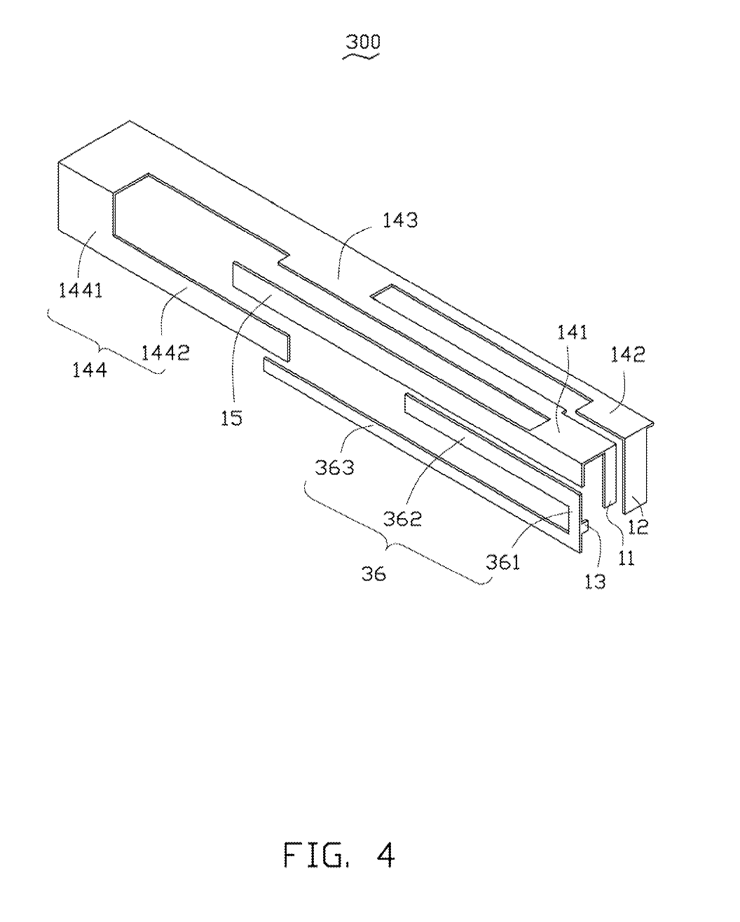

FIG. 4 shows a multiband antenna 300, according to a third exemplary embodiment, differing from the multiband antenna 100 only in that the resonance unit 16 is replaced by another resonance unit 36. The resonance unit 36 includes another first resonance portion 361, another second resonance portion 362, and another third resonance portion 363. The first resonance portion 361 differs from the first resonance portion 161 only in that the first resonance portion 361 is longer than the first resonance portion 161, and the second ground unit 13 is connected to a middle part of a side of the first resonance 361. Both the second resonance portion 362 and the third resonance portion 363 are longitudinal planar sheets positioned coplanar with the first resonance portion 361. The second resonance portion 362 and the third resonance portion 363 are respectively connected to two ends of a same side of the first resonance portion 361, and both extend parallel to the second transceiving unit 15. The second resonance portion 362 is similar to the second resonance portion 162. Due to the first resonance portion 361 being longer than the first resonance portion 161, the third resonance portion 363 and the second transceiving unit 15 are respectively positioned at two opposite sides of the seventh transceiving section 1442. Furthermore, the third resonance portion 363 is longer than the third resonance portion 163, and extends to pass the distal end of the seventh transceiving section 1442.

In use of the multiband antenna 300, when the resonance unit 36 is driven to resonate, at least a current path generated in the second resonance portion 362 and a current path generated in the third resonance portion 363 are generated. Thus, the resonance unit 36 can also serve as a coupled ground resonator and generate additional current paths of at least two different lengths, and thereby receive/send wireless signals of at least two additional frequencies. In this way, the multiband antenna 300 can be used to receive and send wireless signals in a plurality of (more than two) different frequency bands.

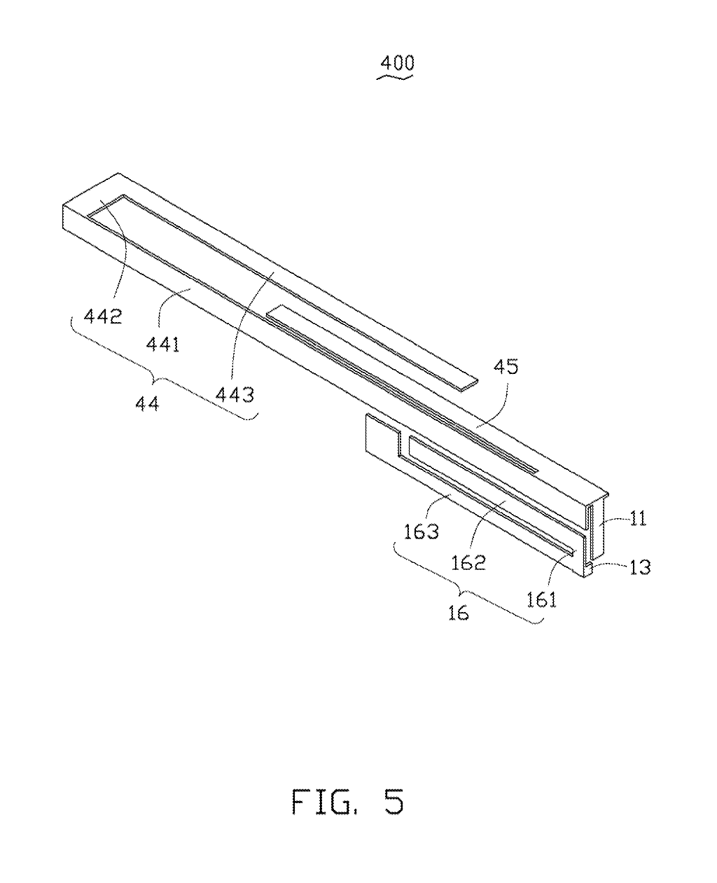

FIG. 5 shows a multiband antenna 400, according to a fourth exemplary embodiment, differing from the multiband antenna 100 only in that the first transceiving unit 14 and the second transceiving unit 15 are respectively replaced by another first transceiving unit 44 and another second transceiving unit 45, and the first ground unit 12 is omitted. The first transceiving unit 44 includes another first transceiving portion 441, another second transceiving portion 442, and a third transceiving portion 443, which are all longitudinal planar sheets. The second transceiving unit 45 is also a longitudinal sheet. Particularly, the second transceiving unit 45 is positioned in a plane that is perpendicular to both the plane in which the feed unit 11 and the second ground unit 13 are positioned and the plane in which the resonance unit 16 is positioned. One end of the second transceiving unit 45 is connected to the feed unit 11. The first transceiving portion 441 is positioned coplanar with the resonance unit 16. One end of a side of the first transceiving portion 441 is connected to an end of a side of the second transceiving unit 45 that is adjacent to the end of the second transceiving unit 45 connected to the feed unit 11. The second transceiving portion 442 and the third transceiving portion 443 are positioned coplanar with the second transceiving unit 45. Another end of the side of the first transceiving portion 441 connected to the second transceiving unit 45 is connected to one end of the second transceiving portion 442. Another end of the second transceiving portion 442 is perpendicularly connected to the third transceiving portion 443. The third transceiving portion 443 and the second transceiving unit 45 extend parallel to each other.

In use of the multiband antenna 400, feed signals input from the feed unit 11 can be respectively transmitted to the first transceiving unit 44 and the second transceiving unit 45 to form a plurality of current paths of different lengths. Thus, the first transceiving unit 44 and the second transceiving unit 45 are respectively enabled to serve as antenna members for receiving and sending wireless signals at different frequencies. As above detailed, the resonance unit 16 is driven to resonate and serves as a coupled ground resonator that is capable of receiving and sending wireless signals of at least two additional frequencies. In this way, the multiband antenna 400 can be used to receive and send wireless signals in a plurality of (more than two) different frequency bands.

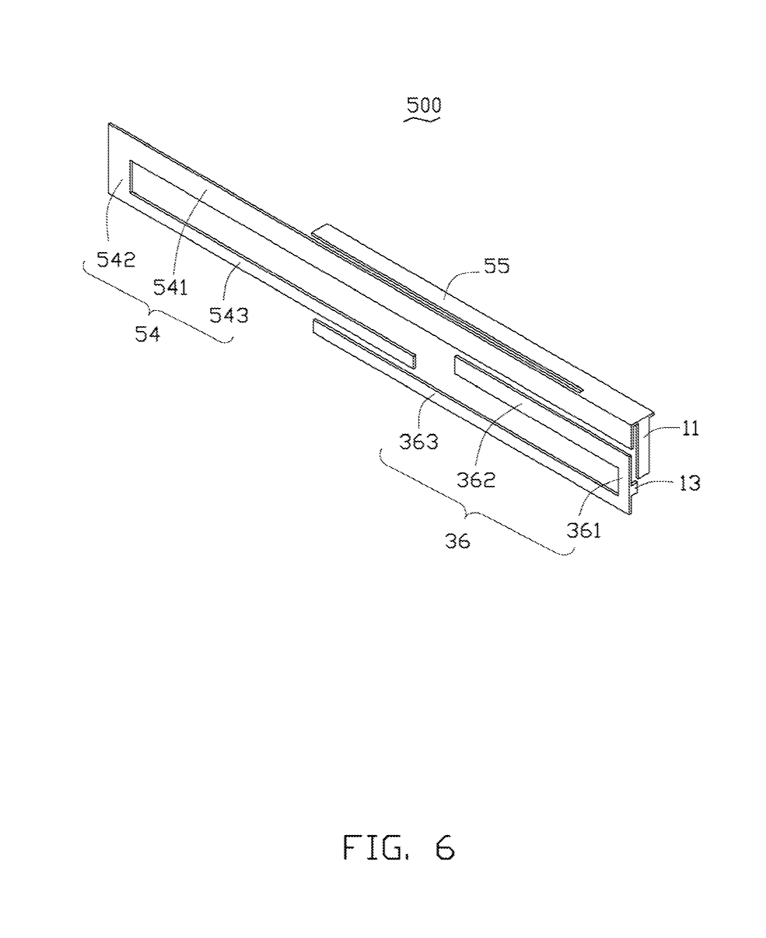

FIG. 6 shows a multiband antenna 500, according to a fifth exemplary embodiment, differing from the multiband antenna 300 only in that the first transceiving unit 14 and the second transceiving unit 15 are respectively replaced by another first transceiving unit 54 and another second transceiving unit 55, and the first ground unit 12 is omitted. The first transceiving unit 54 includes another first transceiving portion 541, another second transceiving portion 542, and another third transceiving portion 543, which are all longitudinal planar sheets positioned coplanar with the resonance unit 36. The first transceiving portion 541 and the second resonance unit 55 are similar to the first transceiving portion 441 and the second resonance unit 45, respectively. Two ends of the second transceiving portion 542 are respectively perpendicularly connected to the first transceiving portion 541 and the third transceiving portion 543. The first transceiving portion 541, the third transceiving portion 543, and the third resonance portion 363 extend parallel to each other, and the first transceiving portion 541 and the third resonance portion 363 are respectively positioned at two opposite sides of the third transceiving portion 543.

In use of the multiband antenna 500, feed signals input from the feed unit 11 can be respectively transmitted to the first transceiving unit 54 and the second transceiving unit 55 to form a plurality of current paths of different lengths. Thus, the first transceiving unit 54 and the second transceiving unit 55 are respectively enabled to serve as antenna members for receiving and sending wireless signals at different frequencies. As above detailed, the resonance unit 36 is driven to resonate and serves as a coupled ground resonator that is capable of receiving and sending wireless signals of at least two additional frequencies. In this way, the multiband antenna 500 can be used to receive and send wireless signals in a plurality of (more than two) different frequency bands.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A multiband antenna, comprising:
a feed unit;
a first transceiving unit connected to the feed unit;
a second transceiving unit connected to the feed unit; and
a resonance unit positioned adjacent to but separate from the feed unit, the first transceiving unit, and the second transceiving unit; wherein when feed signals are input from the feed unit, the feed signals are respectively transmitted to the first transceiving unit and the second transceiving unit to enable the first transceiving unit and the second transceiving unit to respectively receive and send wireless signals of different frequencies, and the resonance unit is driven to resonate and serve as a coupled ground resonator that generates additional current paths of at least two different lengths, such that the resonance unit is enabled to receive and send wireless signals of at least two additional frequencies, and the multiband antenna is further enabled to receive and send wireless signals in more than two frequency bands.

2. The multiband antenna as claimed in claim 1, wherein the first transceiving unit includes a feed portion, a first transceiving portion, and a second transceiving portion, which are all planar sheets; the feed portion connected to the feed unit, the first transceiving portion connected to the feed portion and positioned coplanar with the feed portion, the second transceiving portion connected to the first transceiving portion and positioned in a plane that is perpendicular to the plane in which the feed portion and the first transceiving portion are positioned.

3. The multiband antenna as claimed in claim 2, wherein the first transceiving portion includes a first transceiving section, a second transceiving section, a third transceiving section, a fourth transceiving section, and a fifth transceiving section; the first transceiving section being longitudinal, one end of the first transceiving section connected to the feed portion; the second transceiving section being longitudinal and wider than the first feed section, a side of the first transceiving section that is adjacent to the other end of the first transceiving section connected to an end of a side of the second transceiving section; the third transceiving section being rectangular planar, one side of the third transceiving section connected to the other end of the side of the second transceiving section connected to the first transceiving section; the fourth transceiving section being longitudinal and narrower than the second transceiving section, one end of the fourth transceiving section connected to an end of the second transceiving section, and the fourth transceiving section extending parallel to the first transceiving section; the fifth transceiving section being rectangular and connected to the other end of the fourth transceiving section.

4. The multiband antenna as claimed in claim 3, wherein the second transceiving portion includes a sixth transceiving section and a seventh transceiving section; the sixth transceiving section being rectangular, and the seventh transceiving section being longitudinal; one side of the sixth transceiving section connected to a side of the third transceiving section that is opposite to the side of the third transceiving section connected to the second transceiving section, and another side of the sixth transceiving section that is opposite to the side of the sixth transceiving section connected to the third transceiving section connected to an end of a side of the seventh transceiving section.

5. The multiband antenna as claimed in claim 4, wherein the second transceiving unit is a longitudinal planar sheet positioned coplanar with the second transceiving portion; the second transceiving unit connected to the feed portion, the seventh transceiving section and the plane in which the feed portion and the first transceiving portion are positioned respectively positioned at two opposite sides of the second transceiving unit, and the second transceiving unit extending towards the sixth transceiving section and parallel to the plane in which the feed portion and the first transceiving portion are positioned.

6. The multiband antenna as claimed in claim 5, wherein the feed unit is a planar sheet positioned in a plane that is perpendicular to both the plane in which the feed portion and the first transceiving portion are positioned and the plane in which the second transceiving portion and the second transceiving unit are positioned.

7. The multiband antenna as claimed in claim 6, further comprising a first ground unit and a second ground unit, which are both planar sheets positioned coplanar with the feed unit; the first ground unit connected to the fifth transceiving section, and the second transceiving unit connected to the resonance unit.

8. The multiband antenna as claimed in claim 7, wherein the resonance unit includes a first resonance portion, a second resonance portion, a third resonance portion, and a fourth resonance portion, which are all planar sheets positioned coplanar with the second transceiving portion and the second transceiving unit; all the first resonance portion, the second resonance portion, and the third resonance portion being longitudinal, the first resonance portion connected to the second ground unit; both the second resonance portion and the third resonance portion connected to the first resonance portion, and extending parallel to the second transceiving unit and towards the distal end of the seventh transceiving portion; the third resonance portion being rectangular, the fourth resonance portion connected to the third resonance portion, and the fourth resonance portion positioned at the same side of the third resonance portion as the second resonance portion; both the second resonance portion and the fourth resonance portion positioned between the third resonance portion and the second transceiving unit.

9. The multiband antenna as claimed in claim 7, wherein the resonance unit includes a first resonance portion, a second resonance portion, a third resonance portion, and a fourth resonance portion, which are all longitudinal planar sheets; the first resonance portion and the second resonance portion positioned coplanar with the second transceiving portion and the second transceiving unit, the first resonance portion connected to the second ground unit, and the second resonance portion extending parallel to the second transceiving unit and towards the distal end of the seventh transceiving section; the third resonance portion and the fourth resonance portion positioned coplanar with the feed unit, the first ground unit, and the third ground unit, the third resonance portion connected to the first resonance portion, and the fourth resonance portion connected to the third resonance portion.

10. The multiband antenna as claimed in claim 7, wherein the resonance unit includes a first resonance portion, a second resonance portion, and a third resonance portion, which are all longitudinal planar sheets positioned coplanar with the second transceiving portion and the second transceiving unit; the second ground unit connected to the first resonance; both the second resonance portion and the third resonance portion connected to the first resonance portion, and extending parallel to the second transceiving unit; the second resonance portion extending towards the distal end of the seventh transceiving section; the third resonance portion and the second transceiving unit respectively positioned at two opposite sides of the seventh transceiving section, and the third resonance portion extending to pass the distal end of the seventh transceiving section.

11. The multiband antenna as claimed in claim 1, further comprising a ground unit connected to the resonance unit; wherein both the feed unit and the ground unit are planar sheet, and the feed unit and the ground unit are positioned coplanar with each other.

12. The multiband antenna as claimed in claim 11, wherein the resonance unit is a planar sheet positioned in a plane that is perpendicular to the plane in which the feed unit and the ground unit are positioned.

13. The multiband antenna as claimed in claim 12, wherein the first transceiving unit includes a first transceiving portion, a second transceiving portion, and a third transceiving portion, and the first transceiving portion, the second transceiving portion, the third transceiving portion, and the second transceiving unit are all longitudinal planar sheets; the second transceiving unit connected to the feed unit and positioned in a plane that is perpendicular to both the plane in which the feed unit and the ground unit are positioned and the plane in which the resonance unit is positioned; the first transceiving portion connected to the second transceiving unit and positioned coplanar with the resonance unit; both the second transceiving portion and the third transceiving portion positioned coplanar with the second transceiving unit, the second transceiving portion connected to the first transceiving portion, and the third transceiving portion connected to the second transceiving portion.

14. The multiband antenna as claimed in claim 12, wherein the first transceiving unit includes a first transceiving portion, a second transceiving portion, and a third transceiving portion, and the first transceiving portion, the second transceiving portion, the third transceiving portion, and the second transceiving unit are all longitudinal planar sheets; all the first transceiving portion, the second transceiving portion, and the third transceiving portion positioned coplanar with the resonance unit; the second transceiving unit connected to the feed unit and positioned in a plane that is perpendicular to both the plane in which the feed unit and the ground unit are positioned and the plane in which the resonance unit is positioned; the first transceiving portion connected to the second transceiving unit, the second transceiving portion connected to the first transceiving portion, and the third transceiving portion connected to the second transceiving portion.
